(19) United States
(12) Patent Application Publication
(10) Pub. No.: US 2020/0310431 A1
(43) Pub. Date: Oct. 1, 2020

(54) CONTROL APPARATUS, CONTROL METHOD AND STORAGE MEDIUM

(71) Applicant: HONDA MOTOR CO., LTD., Tokyo (JP)

(72) Inventors: Hideki MATSUNAGA, Wako-shi (JP); Masamitsu TSUCHIYA, Wako-shi (JP); Masaru OTAKA, Wako-shi (JP); Toshiaki TAKANO, Tokyo (JP); Satoshi ONODERA, Tokyo (JP)

(21) Appl. No.: 16/824,019

(22) Filed: Mar. 19, 2020

(30) Foreign Application Priority Data
Mar. 29, 2019 (JP) 2019-067126

(51) Int. Cl. G05D 1/00

(52) U.S. Cl. CPC G05D 1/0088; G05D 1/0011

(57) ABSTRACT

A control apparatus of a vehicle that receives a remote driving service from a remote driving apparatus is provided. The apparatus includes a selection unit configured to select one of a plurality of operation modes that include a remote driving mode, and a control unit configured to control the vehicle in the selected operation mode. During the vehicle is in the remote driving mode, the selection unit is allowed to select another operation mode on the condition of permission from the remote driving apparatus.

### CROSS-REFERENCE TO RELATED APPLICATION

This application claims priority to and the benefit of Japanese Patent Application No. 2019-067126 filed on Mar. 29, 2019, the entire disclosure of which is incorporated herein by reference.

### BACKGROUND OF THE INVENTION

### Field of the Invention

The present invention relates to a control apparatus, a control method, and a storage medium.

### Description of the Related Art

Remote driving techniques, also known as tele-operated drive techniques, in which a vehicle is operated by an operator located in a distant place are known. Japanese Patent Laid-Open No. 2018-077649 mentions that, after a vehicle is moved to a safe position by an operator of a remote driving service, the remote driving service is ended by the operator. If the operation mode of a vehicle can be freely changed by the driver, the satisfaction level of the driver increases. However, it is conceivable that, when a vehicle is running in a remote driving mode, the driver does not sufficiently understand the traffic situation of the vehicle. Therefore, if the remote driving mode is ended and switched to another operation mode based on driver's determination, there is a risk that the operation mode will be switched to another operation mode in an unexpected situation.

### SUMMARY OF THE INVENTION

Some aspects of the present invention provide a technique for appropriately ending a remote driving mode. According to some embodiments, a control apparatus of a vehicle that receives a remote driving service from a remote driving apparatus, the apparatus comprising: a selection unit configured to select one of a plurality of operation modes that include a remote driving mode; and a control unit configured to control the vehicle in the selected operation mode, wherein, during the vehicle is in the remote driving mode, the selection unit is allowed to select another operation mode on the condition of permission from the remote driving apparatus is provided.

### BRIEF DESCRIPTION OF THE DRAWINGS

FIG. 1 is a block diagram illustrating a configuration example of a vehicle according to an embodiment of the present invention.

FIG. 2 is a block diagram illustrating a configuration example of a remote driving apparatus according to an embodiment of the present invention.

FIG. 3 is a schematic diagram illustrating a console example of remote driving according to an embodiment of the present invention.

FIG. 4 is a flowchart illustrating an example of a control method according to an embodiment of the present invention.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A vehicle 1 includes a vehicle control apparatus 2 (hereinafter, simply referred to as “control apparatus 2”) that controls the vehicle 1. The control apparatus 2 includes a plurality of ECUs 20 to 29 that are communicably connected by an in-vehicle network. Each of the ECUs includes a processor represented by a CPU, a memory such as a semiconductor memory, an interface to an external device, and the like. The memory stores programs that are executed by the processor, data that is used by the processor to perform processing, and the like. Each of the ECUs may include a plurality of processors, memories, interfaces, and the like. For example, the ECU 20 includes a processor 20a and a memory 20b. Processing that is performed by the ECU 20 is executed as a result of the processor 20a executing an instruction included in a program stored in the memory 20b. Alternatively, the ECU 20 may include a dedicated integrated circuit such as an ASIC for executing processing that is performed by the ECU 20. The same applies to the other ECUs.

Functions allocated to the (respective) ECUs 20 to 29, and the like will be described below. Note that the number of ECUs and functions allocated to the ECUs can be designed as appropriate, and can be segmentalized further than those in this embodiment, or can be integrated.

The ECU 20 executes running control related to an automated driving function and a remote driving function of the vehicle 1. In this running control, the ECU 20 automatically controls steering and/or acceleration/deceleration of the vehicle 1. The automated driving function is a function of the ECU 20 planning a running route of the vehicle 1, and controlling steering and/or acceleration/deceleration of the vehicle 1 based on this running route. The remote driving function is a function of the ECU 20 controlling steering and/or acceleration/deceleration of the vehicle 1 in accordance with an instruction from an operator outside the vehicle 1. The operator outside the vehicle 1 may be a human or an AI (artificial intelligence). The ECU 20 can execute the automated driving function and the remote operation function in combination. For example, a configuration may also be adopted in which the ECU 20 plans a running route and performs running control when there is no instruction from an operator, and when there is an instruction from an operator, performs running control in accordance with the instruction.

The ECU 21 controls an electronic power steering apparatus 3. The electronic power steering apparatus 3 includes a mechanism for steering front wheels according to a driver's driving operation (steering operation) on a steering wheel 31. The electronic power steering apparatus 3 also includes a motor that exerts drive force for assisting a steering operation and automatically steering the front wheels, a sensor that detects a steering angle, and the like. When the driving state of the vehicle 1 is an automated driving state, the ECU 21 automatically controls the electronic power steering apparatus 3 according to an instruction from the ECU 20, and controls the direction of forward movement of the vehicle 1.

The ECUs 22 and 23 control detection units 41 to 43 that detect the situation of the outside of the vehicle, and perform information processing on detection results. Each detection unit 41 is a camera for shooting an image ahead of the vehicle 1 (which may hereinafter be referred to as “camera 41”), and, in this embodiment, is installed at a roof front part and on an interior side of the front window. By analyzing an image shot by a camera 41, it is possible to extract the contour of an object and a demarcation line (white line, for example) of a traffic lane on a road.

Each detection unit 42 is a LIDAR (Light Detection and Ranging, may hereinafter be referred to as “LIDAR 42”), detects an object in the surroundings of the vehicle 1, and measures the distance from the object. In this embodiment, five LIDARs 42 are provided, two of the five LIDARs 42 being provided at the respective front corners of the vehicle 1, one at the rear center, and two on the respective sides at the rear. Each detection unit 43 is a millimeter-wave radar (which may hereinafter be referred to as “radar 43”), detects an object in the surroundings of the vehicle 1, and measures the distance from a marker. In this embodiment, five radars 43 are provided, one of the radars 43 being provided at the front center of the vehicle 1, two at the respective front corners, and two at the rear corners.

The ECU 22 controls one camera 41 and the LIDARs 42, and performs information processing on their detection results. The ECU 23 controls the other camera 41 and the radars 43, and performs information processing on their detection results. By providing two sets of apparatuses that detect the surrounding situation of the vehicle, the reliability of detection results can be improved, and by providing detection units of different types such as cameras, LIDARs, and radars, the surrounding environment of the vehicle can be multilaterally analyzed.

The ECU 24 controls a gyro sensor 5, a GPS sensor 24b, and a communication apparatus 24c, and performs information processing on their detection results or communication results. The gyro sensor 5 detects rotary movement of the vehicle 1. A course of the vehicle 1 can be determined based on a detection result of the gyro sensor 5, a wheel speed, and the like. The GPS sensor 24b detects the current position of the vehicle 1. The communication apparatus 24c wirelessly communicates with a server that provides map information and traffic information, and acquires such information. The ECU 24 can access a database 24a of map information built in the memory, and the ECU 24 searches for a route from the current location to a destination, and the like. The ECU 24, the map database 24a, and the GPS sensor 24b constitute a so-called navigation apparatus.

The ECU 25 includes a communication apparatus 25a for inter-vehicle communication. The communication apparatus 25a wirelessly communicates with another vehicle in the surroundings thereof, and exchanges information with the vehicle. The communication apparatus 25a is also used for communication with an operator outside the vehicle 1.

The ECU 26 controls a power plant 6. The power plant 6 is a mechanism for outputting drive force for rotating the drive wheels of the vehicle 1, and includes an engine and a transmission, for example. For example, the ECU 26 controls output of the engine in accordance with a driver's driving operation (an accelerator operation or an accelerating operation) detected by an operation detection sensor 7a provided on an accelerator pedal 7A, and switches the gear stage of the transmission based on information regarding the vehicle speed detected by a vehicle speed sensor 7c. When the driving state of the vehicle 1 is an automated driving state, the ECU 26 automatically controls the power plant 6 in accordance with an instruction from the ECU 20, and controls the acceleration/deceleration of the vehicle 1.

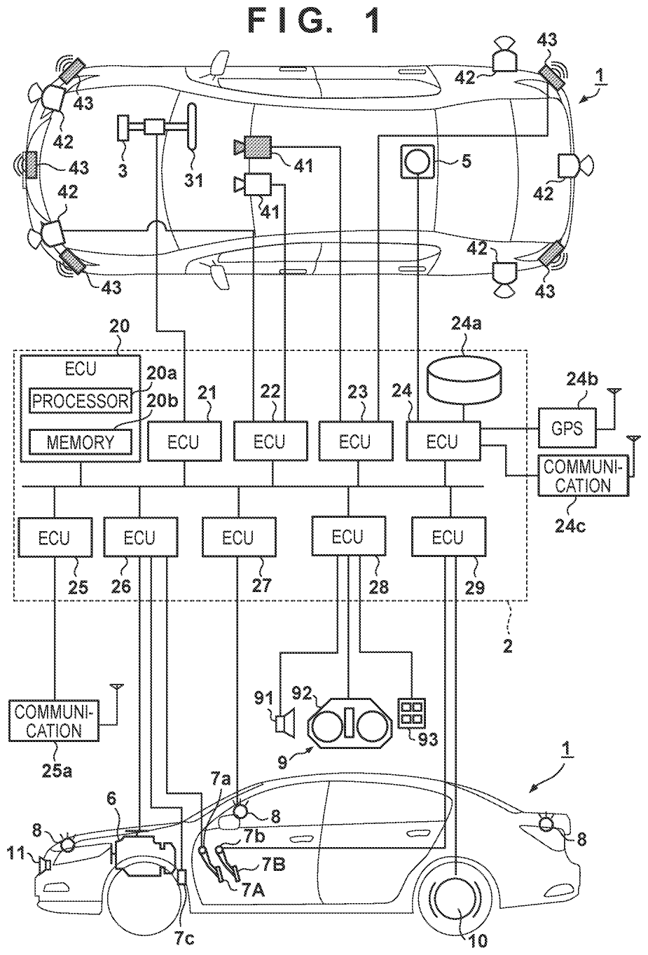

The ECU 27 controls illumination apparatuses 8 (lights such as headlights and taillights) that include direction indicators (blinkers). In the example in FIG. 1, the illumination apparatuses 8 are provided on door mirrors, at the front, and at the rear of the vehicle 1. The ECU 27 further controls an acoustic apparatus 11 that includes a horn and is directed to the outside of the vehicle. The illumination apparatuses 8, the acoustic apparatus 11, or a combination thereof has a function of providing information to the outside the vehicle 1.

The ECU 28 controls an input/output apparatus 9. The input/output apparatus 9 outputs information to the driver, and receives information from the driver. An audio output apparatus 91 notifies the driver of information using sound. A display apparatus 92 notifies the driver of information through image display. The display apparatus 92 is installed in front of the driver's seat, for example, and constitutes an instrument panel, or the like. Note that, here, sound and display are illustrated, but information may be notified using vibration and light. In addition, information may also be notified using a combination of some of sound, display, vibration, and light. Furthermore, the combination or a notification aspect may be different according to the level of information to be notified (for example, an emergency level). Input apparatuses 93 are a group of switches arranged at positions so as to enable the driver to perform an operation on the switches to give an instruction to the vehicle 1, but may include an audio input apparatus. The ECU 28 can give guidance related to running control of the ECU 20. The guidance will be described later in detail. The input apparatuses 93 may also include a switch used for controlling an operation of running control by the ECU 20. The input apparatuses 93 may also include a camera for detecting the direction of a line of sight of the driver.

The ECU 29 controls a brake apparatus 10 and a parking brake (not illustrated). The brake apparatus 10 is, for example, a disk brake apparatus, is provided for each of the wheels of the vehicle 1, and decelerates or stops the vehicle 1 by imposing resistance to rotation of the wheels. The ECU 29 controls activation of the brake apparatus 10, for example, in accordance with a driver's driving operation (brake operation) detected by an operation detection sensor 7b provided on a brake pedal 7B. When the driving state of the vehicle 1 is an automated driving state, the ECU 29 automatically controls the brake apparatus 10 in accordance with an instruction from the ECU 20, and controls deceleration and stop of the vehicle 1. The brake apparatus 10 and the parking brake can also be activated to maintain a stopped state of the vehicle 1. In addition, if the transmission of the power plant 6 includes a parking lock mechanism, this can also be activated in order to maintain a stopped state of the vehicle 1.

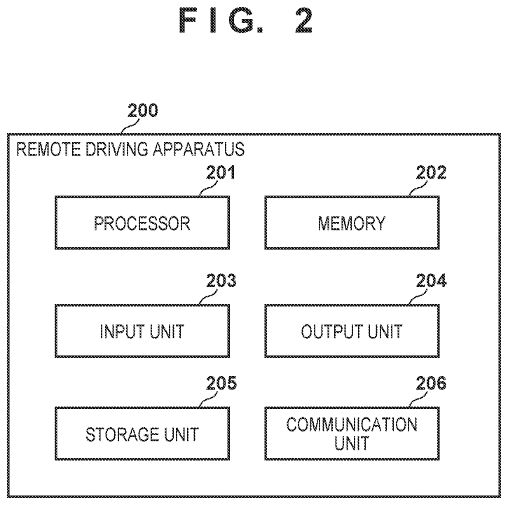

A configuration of a remote driving apparatus 200 according to some embodiments of the present invention will be described with reference to the block diagram in FIG. 2. The remote driving apparatus 200 is an apparatus that provides a remote driving service to a vehicle that has a remote driving function. The remote driving apparatus 200 is positioned at a remote location from a vehicle to which the service is provided.

The remote driving apparatus 200 may be able to provide the remote driving service in a plurality of operation modes. The plurality of operation modes of the remote driving service may include a leading mode and an assisting mode. The leading mode refers to an operation mode in which the operator of the remote driving apparatus 200 specifies control amounts (for example, a steering angle, an accelerator pedal position, a brake pedal position, a position of the directional signal lever, and on/off of the lights) of the vehicle. The assisting mode refers to an operation mode in which the vehicle (specifically, the ECU 20) determines control amounts of the vehicle in accordance with a path plan specified by the operator of the remote driving apparatus 200. In the assisting mode, the operator of the remote driving apparatus 200 may generate and designate a path plan for themselves, or may adopt and designate a path plan suggested by the vehicle.

The remote driving apparatus 200 includes constituent elements shown in FIG. 2. A processor 201 controls overall operations of the remote driving apparatus 200. The processor 201 functions as a CPU, for example. A memory 202 stores programs that are used for operations of the remote driving apparatus 200, temporary data, and the like. The memory 202 is realized by a ROM and a RAM, for example. An input unit 203 is used by the user of the remote driving apparatus 200 to perform input to the remote driving apparatus 200. When a human operates the remote driving apparatus 200, the user of the remote driving apparatus 200 is this human, and when an AI operates the remote driving apparatus 200, the user of the remote driving apparatus 200 is a human (monitoring person) that monitors operations of the AI. An output unit 204 is used for outputting information from the remote driving apparatus 200 to the user. A storage unit 205 stores data used for operations of the remote driving apparatus 200. The storage unit 205 is realized by a storage apparatus such as a disk drive (for example, an HDD or an SSD). A communication unit 206 provides a function of the remote driving apparatus 200 communicating with another apparatus (for example, a vehicle to be remotely driven), and is realized by a network card or an antenna, for example.

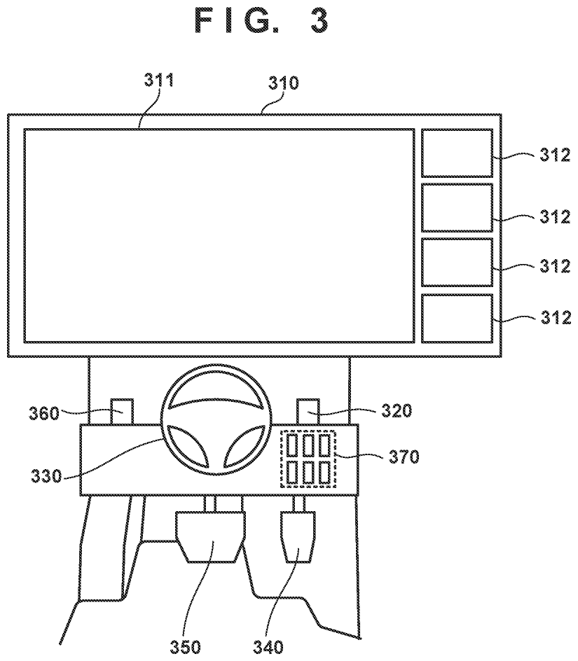

A configuration example of the input unit 203 and the output unit 204 of the remote driving apparatus 200 will be described with reference to the schematic diagram in FIG. 3. In this configuration example, the output unit 204 is constituted by a display apparatus 310 and an acoustic apparatus 320, and the input unit 203 is constituted by a steering wheel 330, an accelerator pedal 340, a brake pedal 350, a microphone 360, and a plurality of switches 370.

The display apparatus 310 is an apparatus that outputs visual information for providing the remote driving service. The acoustic apparatus 320 is an apparatus that outputs audio information for providing the remote driving service. A screen displayed on the display apparatus 310 includes one main region 311 and a plurality of sub regions 312. Information regarding a vehicle to be controlled from among a plurality of vehicles to which the remote driving service is to be provided is displayed in the main region 311. The vehicle to be controlled is a vehicle to which an instruction from the remote driving apparatus 200 is transmitted. Information regarding a vehicle other than the vehicle to be controlled from among the plurality of vehicles to which the remote driving service is provided is displayed in each of the sub regions 312. A vehicle other than the vehicle to be controlled may be called a “vehicle to be monitored”. When one remote driving apparatus 200 provides the remote driving service to a plurality of vehicles, the operator switches a vehicle displayed on the main region 311 (i.e., the vehicle to be controlled) as appropriate. Information displayed on the main region 311 and the sub regions 312 includes the traffic condition in the surrounding of the vehicle, the speed of the vehicle, and the like.

The steering wheel 330 is used for controlling the steering amount of the vehicle to be controlled, in the leading mode. The accelerator pedal 340 is used for controlling the accelerator pedal position of the vehicle to be controlled, in the leading mode. The brake pedal 350 is used for controlling the brake pedal position of the vehicle to be controlled, in the leading mode. The microphone 360 is used for inputting audio information. Audio information input to the microphone 360 is transmitted to the vehicle to be controlled, and is regenerated in the vehicle.

The plurality of switches 370 are used for inputting various types of instructions for providing the remote driving service. For example, the plurality of switches 370 include a switch for switching the vehicle to be controlled, a switch for performing an instruction of a determination result of the operator in the assisting mode, a switch for switching a plurality of operation modes, and the like.

The remote driving apparatus 200 described with reference to FIGS. 2 and 3 can provide both the leading mode and the assisting mode. Alternatively, the remote driving apparatus 200 can provide only one of the leading mode and the assisting mode. When the leading mode is not provided, the steering wheel 330, the accelerator pedal 340, and the brake pedal 350 can be omitted. In addition, the remote driving service may be provided by a plurality of remote driving apparatuses 200 in cooperation. A configuration may be adopted, in this case, a remote driving apparatuses 200 can take over a vehicle to which the service is to be provided, from another remote driving apparatus 200.

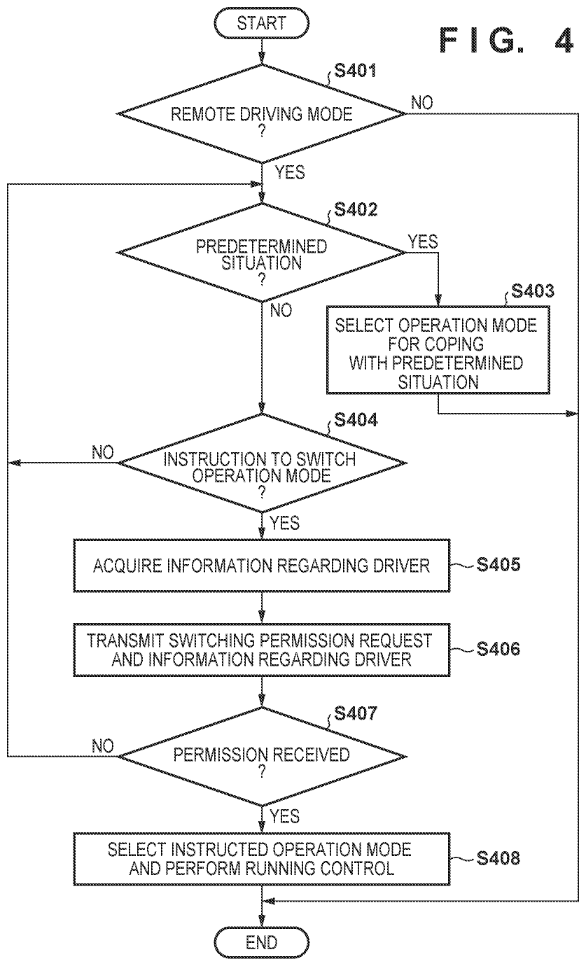

An example of a control method that is performed by the control apparatus 2 of the vehicle 1 will be described with reference to FIG. 4. Particularly, a method for the control apparatus 2 to switch the operation mode of the vehicle 1 will be described. This method may be performed by a processor (for example, the processor 20a) of the control apparatus 2 executing a program stored in a memory (for example, the memory 20b). Alternatively, some or all of the processes of the method may be executed by a dedicated circuit such as an ASIC (application specific integrated circuit). In the former case, the processor serves as a constituent element for a specific operation, and, in the latter case, the dedicated circuit serves as a constituent element for a specific operation. The control method in FIG. 4 is executed repeatedly while the vehicle 1 is running.

The control apparatus 2 of the vehicle 1 selects one of a plurality of operation modes, and performs running control of the vehicle 1 in the selected operation mode. The plurality of operation modes include, for example, a remote driving mode, an automated driving mode, a manual driving mode, and an emergency stop mode. The remote driving mode refers to an operation mode in which the vehicle 1 runs while receiving a remote driving service from the remote driving apparatus 200. The automated driving mode refers to an operation mode in which the vehicle 1 automatically runs in accordance with determination made by the ECU 20. The manual driving mode refers to an operation mode in which the vehicle 1 runs in accordance with operations performed by the driver of the vehicle 1. The emergency stop mode refers to an operation mode aimed at automatically stopping the vehicle 1 in a safe place in accordance with determination made by the ECU 20.

In step S401, the control apparatus 2 determines whether or not the current operation mode of the vehicle 1 is the remote driving mode. If the current operation mode is the remote driving mode (“YES” in step S401), the control apparatus 2 advances the procedure to step S402, and otherwise the control apparatus 2 ends the procedure. A known method may be used as a control method when the current operation mode is not the remote driving mode, and thus a description thereof is omitted. The processing from step S402 onward is executed when the vehicle 1 is the remote driving mode.

In step S402, the control apparatus 2 determines whether or not the current situation of the vehicle 1 is a predetermined situation. If the current situation is a predetermined situation (“YES” in step S402), the control apparatus 2 advances the procedure to step S403, and otherwise (“NO” in step S402) the control apparatus 2 advances the procedure to step S404. Predetermined situations may include, for example, a situation in which it is not possible or desirable to continue the remote driving mode. For example, the predetermined situations may also include a situation in which the quality of communication between the vehicle 1 and the remote driving apparatus 200 decreases to a threshold or lower. For example, when communication between the vehicle 1 and the remote driving apparatus 200 is disconnected, the quality of communication decreases to a threshold or lower. Situations in which it is not desirable to continue the remote driving mode include, for example, a situation in which there is the possibility that the vehicle 1 will collide with a physical body (for example, another vehicle or a guard rail), and it is necessary to start an automated driving function or a driving assist function without waiting for an instruction from the remote driving apparatus 200, and avoid the physical body urgently. In such a case, in step S403, the control apparatus 2 selects an operation mode for coping with the predetermined situation, and performs running control in the selected operation mode. For example, when communication between the vehicle 1 and the remote driving apparatus 200 is disconnected, the control apparatus 2 may make a switch to the automated driving mode or the emergency stop mode. The control apparatus 2 may make a switch to the emergency stop mode in a situation in which a physical body needs to be avoided urgently.

In step S404, the control apparatus 2 determines whether or not an instruction to switch the operation mode has been received from the driver. If an instruction to switch the operation mode has been received (“YES” in step S404), the control apparatus 2 advances the procedure to step S405, and otherwise (“NO” in step S404) the control apparatus 2 advances the procedure to step S402, and returns the procedure to the determination as to whether or not the current situation is a predetermined situation.

In step S405, the control apparatus 2 acquires information regarding the driver. The information regarding the driver may be information for determining whether or not the driver has appropriately given an instruction to make a switch, for example. The information regarding the driver may include, for example, the current image of the driver, the current biological data (pulse, etc.) of the driver, the current orientation of the driver, and the like.

In step S406, the control apparatus 2 requests the remote driving apparatus 200 for permission to switch the operation mode from the remote driving mode to another operation mode. The control apparatus 2 may transmit the information regarding the driver acquired in step S405 to the remote driving apparatus 200 along with this request. If this information is not transmitted, step S405 can be omitted.

On receiving the request for permission for a switch, the operator of the remote driving apparatus 200 determines whether or not the vehicle 1 may end the remote driving mode, based on the vehicle 1 and the situation of the surroundings of the vehicle 1. The operator can perform this determination with even higher accuracy based on the information regarding the driver. If the remote driving mode may be ended, the operator of the remote driving apparatus 200 notifies the vehicle 1 of permission, and otherwise the operator of the remote driving apparatus 200 does not notify the vehicle 1 of permission.

In step S407, the control apparatus 2 determines whether or not permission has been received from the remote driving apparatus 200. If permission has been received (“YES” in step S407), the control apparatus 2 advances the procedure to step S408, and otherwise (“NO” in step S407) the control apparatus 2 advances the procedure to step S402, returns the procedure to the determination as to whether or not the current situation is a predetermined situation. In step S408, the control apparatus 2 makes a switch to the operation mode specified in step S404.

In the above embodiment, the control apparatus 2 changes the operation mode of the vehicle 1 from the remote driving mode to another operation mode, on the condition of permission from the remote driving apparatus 200. Therefore, the remote driving mode can be appropriately ended. In addition, in a predetermined situation such as an emergency, the control apparatus 2 can execute an operation mode other than the remote driving mode without permission from the remote driving apparatus 200.

### Overview of Embodiments

### Configuration 1

A control apparatus (2) of a vehicle (1) that receives a remote driving service from a remote driving apparatus (200), the apparatus comprising:

a selection unit configured to select one of a plurality of operation modes that include a remote driving mode (S403, S408); and

a control unit configured to control the vehicle in the selected operation mode (S403, S408),

wherein, during the vehicle is in the remote driving mode, the selection unit is allowed to select another operation mode on the condition of permission from the remote driving apparatus (S407).

According to this configuration, the remote driving mode can be ended appropriately.

### Configuration 2

The control apparatus according to configuration 1, further comprising:

an acquisition unit configured to acquire information regarding a driver of the vehicle (S405); and

a communication unit configured to transmit the information regarding the driver to the remote driving apparatus (S406).

According to this configuration, the remote driving mode can be more appropriately ended.

### Configuration 3

The control apparatus according to configuration 1 or 2,

wherein, when the vehicle is in a predetermined situation, the selection unit selects an operation mode for coping with the predetermined situation without permission from the remote driving apparatus (S403).

According to this configuration, it is not necessary to wait for permission from the remote driving apparatus at the time of an emergency, for example.

### Configuration 4

The control apparatus according to configuration 3,

wherein the predetermined situation includes a situation in which a quality of communication between the vehicle and the remote driving apparatus decreases to a threshold or lower.

According to this configuration, when the communication quality deteriorates, and the remote driving cannot be continued, it is not necessary to wait for permission from the remote driving apparatus.

### Configuration 5

The control apparatus according to configuration 3 or 4,

wherein the predetermined situation includes a situation in which the control apparatus started an automated driving function or a driving assist function.

According to this configuration, when starting the automated driving function or the driving assist function based on determination performed by the control apparatus, it is not necessary to wait for permission from the remote driving apparatus.

### Configuration 6

A non-transitory storage medium that stores a program for causing a computer to function as the control apparatus according to any one of configurations 1 to 5.

According to this configuration, each of the above configurations can be realized in a form of a storage medium that stores a program.

### Configuration 7

A control method of a vehicle (1) that receives a remote driving service from a remote driving apparatus (200), the method comprising:

selecting one of a plurality of operation modes that include a remote driving mode (S403, S408); and

performing running control of the vehicle in the selected operation mode (S403, S408),

wherein, in the selecting, during the vehicle is in the remote driving mode, it is allowed to select another operation mode on the condition of permission from the remote driving apparatus (S407).

According to this configuration, the remote driving mode can be ended appropriately.

The invention is not limited to the foregoing embodiments, and various variations/changes are possible within the spirit of the invention.

What is claimed is:

1. A control apparatus of a vehicle that receives a remote driving service from a remote driving apparatus, the apparatus comprising:
a selection unit configured to select one of a plurality of operation modes that include a remote driving mode; and
a control unit configured to control the vehicle in the selected operation mode,
wherein, during the vehicle is in the remote driving mode, the selection unit is allowed to select another operation mode on the condition of permission from the remote driving apparatus.

2. The control apparatus according to claim 1, further comprising:
an acquisition unit configured to acquire information regarding a driver of the vehicle; and
a communication unit configured to transmit the information regarding the driver to the remote driving apparatus.

3. The control apparatus according to claim 1,
wherein, when the vehicle is in a predetermined situation, the selection unit selects an operation mode for coping with the predetermined situation without permission from the remote driving apparatus.

4. The control apparatus according to claim 3,
wherein the predetermined situation includes a situation in which a quality of communication between the vehicle and the remote driving apparatus decreases to a threshold or lower.

5. The control apparatus according to claim 3,
wherein the predetermined situation includes a situation in which the control apparatus started an automated driving function or a driving assist function.

6. A non-transitory storage medium that stores a program for causing a computer to function as the control apparatus according to claim 1.

7. A control method of a vehicle that receives a remote driving service from a remote driving apparatus, the method comprising:
selecting one of a plurality of operation modes that include a remote driving mode; and
performing running control of the vehicle in the selected operation mode,
wherein, in the selecting, during the vehicle is in the remote driving mode, it is allowed to select another operation mode on the condition of permission from the remote driving apparatus.
